(19) United States
(12) Patent Application Publication
(10) Pub. No.: US 2022/0247909 A1
(43) Pub. Date: Aug. 4, 2022

(54) DEVICE AND METHOD FOR OBSERVING MICROPARTICLES AND NANOPARTICLES

(71) Applicant: Myriade, Paris (FR)

(72) Inventors: Matthieu Greffet, Verrières-Le-Buisson (FR); Luc Talini, Paris (FR)

(73) Assignee: Myriade, Paris (FR)

(21) Appl. No.: 17/432,048

(22) PCT Filed: Mar. 10, 2020
(86) PCT No.: PCT/EP2020/056382

§ 371 Date: Aug. 18, 2021

(30) Foreign Application Priority Data
Mar. 13, 2019 (FR) 1902589

(51) Int. Cl. H04N 5/235; G06T 5/40; G06T 5/00; G02B 21/36

(52) U.S. Cl. CPC H04N 5/2352; G06T 5/40; G06T 2207/10056; G02B 21/365; G06T 5/009

(57) ABSTRACT

A method for obtaining an image, using a microscope (1), of a set of particles, which are conjugated with a digital camera (3) via the microscope (1), the set of particles comprising nanoparticles not resolved by the microscope (1) and microparticles resolved by the microscope (1), wherein the particles are illuminated by a light source (2), and wherein the light source (2) illuminates the digital camera (3) via the microscope (1). The method comprises the following steps;
overexposing an image recorded by the digital camera (3), by means of the light source (2), in order to cause to appear, in the recorded image, to an observer, variations in light intensity for the nanoparticles;
digitally correcting the overexposure of the recorded image, in order to cause to appear in the recorded image, to the observer, variations in light intensity for the microparticles simultaneously with the variations in light intensity for the nanoparticles.

### FIELD OF THE INVENTION

This present disclosure relates to the field of microscopy applied to observation of particle mixtures that are natural, in the sense they are unfiltered, said natural mixtures comprising, in an unpredictable way, particles resolved by an optical microscope, or microparticles, and particles not resolved by an optical microscope, or nanoparticles.

### BACKGROUND

More precisely, the present disclosure relates to observation, via a microscope and a camera, of such mixtures, and especially of mixtures such as these that are composed of biological particles, forming phase objects, that are in particular in Brownian motion in a liquid medium, an aqueous medium in particular.

This present disclosure also relates to the observation of mixtures containing amplitude micro- or nano-objects, i.e., micro- or nano-objects that attenuate the light that they transmit or reflect or absorb, as for example gold microparticles and gold nanoparticles do, especially when in Brownian motion in a liquid medium.

This present disclosure thus relates, generally, to the observation of mixtures of phase or amplitude objects, which are micro- or nano-objects, especially when subject to Brownian motion, but also to the observation of particles of any size and which may be immobile.

Bright-field resolved optical microscopy, which makes it possible to form an intensity image of an object that is resolved by the microscope, i.e., an object the lateral size of which is larger than the lateral resolution limit of the microscope, using a source (especially a thermal source, light-emitting diode, laser, etc.) of illuminating light that is collected by the microscope, is known in the prior art. In this system, unresolved particles are, in general, invisible, and therefore cannot be observed at the same time as resolved particles.

An optical method and device for interference-based detection of nanoparticles in a fluid sample that is not natural, because it is filtered beforehand so as to contain only unresolved particles, is also known in the prior art, for example from the document published under the number FR3027107 (BOCCARA). Specifically, this document mentions an interferometric method for observing, via a microscope and a camera, biological nanoparticles in Brownian motion in an aqueous medium. In addition, the bright-field interferometric method disclosed in this document is presented, in particular on page 6 of this document, as requiring, in all cases, a sample that is filtered beforehand and that contains only particles smaller than a few hundred nanometers, Given the resolution in the visible of the optical microscope used in this document, which is just a few hundred nanometers, this document therefore teaches that the observed samples must contain only unresolved particles. In this system, resolved particles, which are subtracted from the object to be observed via physical filtering beforehand, are thus, in principle, absent from any image of the observed object, and therefore cannot be observed at the same time as unresolved particles.

In the prior art, the technical problem of observing, in an image, by means of a microscope and of a camera, a mixture of particles resolved by the microscope and of particles not resolved by the microscope, referred to as natural mixture, is therefore a difficult problem, especially when the particles are phase objects in Brownian motion in a liquid matrix.

Operations for increasing the contrast of images, and especially of images of resolved phase objects, whether they are in Brownian motion or not, are also known in the prior art, In particular, these operations for increasing the contrast of an image consist of transformations of a histogram of the image. In image processing, histogram transformations modify images by processing each pixel independently. These transformations appear in almost any image processing and analysis process. In particular, these transformations are commonly applied to digital images taken by a camera which records the images in the form of pixels each of which is assigned one grayscale level, or a plurality of grayscale levels associated with colors: during pre-processing to normalize the image, before it has been recorded, or during post-processing to improve observation, after the image has been recorded.

In the present document, the following definitions apply:

“Normalization of an image”: Extension of the histogram of an image, before or after it has been recorded, so that this histogram comprises grayscale levels extending over the entire range of grayscale levels of the sensor used to take the recording, or of a display used for the observation, or of the eye of an observer, in order to maximize the contrast seen by a human observer.

“Brownian motion”: Spontaneous movement of particles in a liquid or viscous medium, caused by thermal agitation and preventing sedimentation of particles under the effect of gravity.

“Stroboscope”: Device for limiting the exposure time of an image taken by a camera, and allowing a movement to be frozen; a “stroboscopic image” is understood to be an image with an exposure time that is short enough to freeze a particular movement.

“Digital contrast enhancement”: Set of digital methods allowing the number of details visible in an image, by a human observer or a system able to implement such methods, to be increased, especially via normalization of the image, and allowing overexposure in a digital image to be corrected.

### PRESENTATION OF THE INVENTION

The present disclosure relates to a method for obtaining an image, using a microscope, of a set of particles, which are conjugated with a digital camera via the microscope, the set of particles comprising nanoparticles not resolved by the microscope and microparticles resolved by the microscope, wherein the particles are illuminated by a light source, and wherein the light source illuminates the digital camera via the microscope. This method comprises the following steps:
overexposing an image recorded by the digital camera, by means of the light source, in order to cause to appear, in the recorded image, to an observer, variations in light intensity for the nanoparticles;
digitally correcting the overexposure of the recorded image, in order to cause to appear in the recorded image, to the observer, variations in light intensity for the microparticles simultaneously with the variations in light intensity for the nanoparticles.

As variants, the method may comprise the following features, which may be implemented alone or combined with one another (except where this would lead to a major technical incompatibility):

the nanoparticles comprise viruses and the microparticles comprise virus aggregates;

the digital correction of the overexposure is obtained via transformation of the histogram of the image;

the transformation of the histogram of the image is an extension of the histogram of the image;

the transformation of the histogram of the image is a translation of the histogram of the image;

the transformation of the histogram of the image comprises a translation of the histogram of the image and an extension of the histogram of the image;

the extension of the histogram of the image is linear;

the extension of the histogram of the image is non-linear.

The present disclosure also relates to a device for implementing the above method, wherein the light source is of sufficient light intensity to overexpose an image recorded by the digital camera via the microscope, so as to cause to appear variations in light intensity for a nanoparticle conjugated with the digital camera via the microscope. The device comprises digital means for correcting the exposure of an image recorded by the camera. The teaching of the present disclosure applies to any combination of the methods, variants and devices mentioned.

The aforementioned features and advantages, and others, will become apparent on reading the following detailed description of embodiments of the device and of the proposed method. This detailed description makes reference to the appended drawings.

### BRIEF DESCRIPTION OF THE DRAWINGS

The appended drawing is schematic and is not necessarily to scale; it aims above all to illustrate the principles of the invention.

FIG. 1 shows an example of a device for observing particles.

### DETAILED DESCRIPTION

Examples of embodiments of the proposed invention are described in detail below, with reference to the appended drawing. These examples illustrate the features and advantages of the invention. It will however be recalled that the invention is not limited to these examples.

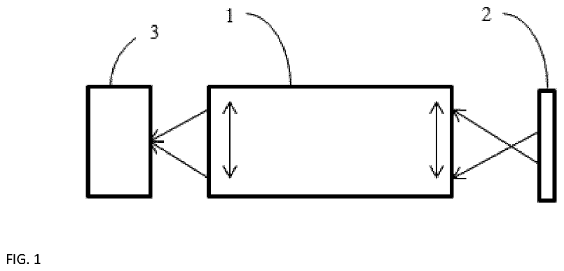

The device of FIG. 1 comprises a microscope 1; a light source 2 that illuminates the field of the microscope; and a camera 3. The camera is placed in an image plane that is conjugated with the object focal plane of the microscope 1 and collects light direct from the source 2 of illumination via the microscope so as to form a bright-field image. A stroboscope (not shown in this figure) or any other means for limiting exposure time, and digital image-processing means for improving the contrast of the acquired image, may be provided. The bright-field configuration is set up so as, on the one hand, to collect intensity variations due to resolved phase objects located in the field of the microscope and, on the other hand, to collect the light scattered by unresolved phase objects also located in the field of the microscope.

Modulation of the direct light by the resolved objects is used to observe the resolved objects, and modulation due to interference with light scattered from unresolved objects in the vicinity of the object focal plane conjugated with the camera is used to observe unresolved objects.

The shown device therefore makes it possible to observe, in the same image and in the same frame of reference, resolved and unresolved objects located in a section extending over the depth of field of the microscope, from the object focal plane of the microscope, or more generally in a section extending over the depth of field of the microscope from the object plane conjugated with the plane of the camera by the microscope. The camera is assumed to be planar, although a camera conforming to the field curvature of the microscope may be envisioned without departing from the teaching of the present disclosure.

In a first embodiment, illustrated by the example of FIG. 1, the device comprises a microscope 1 or optical system, a light source 2 or source of illumination or source and a camera 3. In all the embodiments, the invention thus comprises the source 2 of the illumination collected by the microscope 1 and the camera 3. An object to be observed is placed in the object space of the microscope 1 and is thus illuminated and imaged on the camera 3 in a bright-field mode.

Preferably, the illumination provided by the source 2 is collimated so as to maximize the contrast of the interference signals observed for nanoparticles conjugated with the camera 3.

A source 2 of the highest possible luminous power, or in any case a source that is powerful enough to fill the capacity or depth of the wells of the camera in the exposure time, is preferred. It may be a source 2 with a wavelength bandwidth that is as narrow as possible.

It is thus possible to use, as source 2, a light-emitting diode that emits visible light (for example a royal-blue Thorlabs LED of reference M405LP1) with a wavelength centered on 405 nm.

However, it is also possible to use other light sources of broader spectrum, provided simply that they allow, on account of the signal-to-noise ratio that they allow to be achieved, nanoparticles of given sizes to be detected. Thus, a white light-emitting diode (for example a Thorlabs LED of reference MWWHLPI) has been used to provide collimated illumination in one exemplary embodiment. Although less suitable than the above blue LED, which is narrower in spectrum, such a white LED may nevertheless allow nanoparticles (NPs) of 100 nm to be seen (in contrast to 10 nm with the blue LED). Such nanoparticles being unresolved in the visible.

An objective of high numerical aperture (NA) is preferred, so as to collect a maximum of the light scattered by nanoparticles (NP).

A microscope 1 equipped with an oil-immersion objective, for example an Olympus ×100 objective, may thus be used. The conditions of illumination may be either defined by the propagation in free space of the source, or defined by a condenser allowing the conditions of illumination to be changed (Kohler illumination, critical illumination or any other type of illumination, in particular collimated illumination). In all the embodiments, the magnification of the optical system, the size of the pixels of the camera 3 and the acquisition rate of the camera 3, in number of images per second, are chosen so that the movement between two acquired or recorded images of a nanoparticle is quantifiable.

A bright-field image is, in all cases, imaged, via the microscope 1, on a camera 3 of high dynamic range, i.e. of large well depth, for example a Photon Focus CMOS camera of reference PHF-MV-D1024E-160-CL-12. Another camera possessing more pixels and a shallower well depth may also be used if the pixels are binned.

The camera 3 is preferably placed in an image plane conjugated with the object focal plane of the microscope 1, in an optical configuration in which optical correction of aberrations is optimized and the diffraction limit is generally reached.

With respect to adjustment of the illumination by the source 2, it is ensured that the microscope 1 forms a bright-field image of a sample comprising resolved particles and laterally unresolved particles, an unfiltered natural sample for example. For a minimum visible wavelength, i.e. 400 nm, and an objective of numerical aperture equal to 1, the resolution limit is, as known, close to 200 nm. A test sample in which immobile resolved and unresolved particles are present may also be used.

A sample consisting of unfiltered natural water, which a priori contains viruses and virus aggregates forming a population of phase objects, of dimensions comprised between 10 nm and 10 μm, may in particular be observed with the invention. Any liquid sample containing biological particles may be observed with the device and method of the invention. Generally, the invention is particularly useful for observing natural media comprising phase objects in Brownian motion. in certain embodiments, it is possible, on the one hand, to define an acquisition rate of the camera of the order of about 130 images per second or more and, on the other hand, to apply, to each image or stroboscopic image taken by the camera, a contrast-enhancing operation suitable for overexposed images (i.e. the exposure of which has been maximized without saturating the image) obtained with a bright-field microscope. Any increase in camera acquisition rate compatible with a given signal-to-noise ratio is therefore favorable to the observation of increasingly small unresolved objects, in the presence of resolved objects. The acquisition rate is, in all cases, chosen to be as high as possible, in order to allow the Brownian motion of the particles to be tracked as well as possible, while ensuring the wells of the camera are completely filled, in order to minimize shot noise, the main source of noise in certain embodiments.

The contrast-enhancing operation may be applied in real time if the image-processing means allow it, or a posteriori to a sequence of stroboscopic images stored in an image memory.

It is thus possible to make appear, to a human eye, in an image obtained with a single device, contrast-enhanced interference patterns due to interference between the direct light and light scattered by the particles not resolved by the microscope, and optical images of the particles resolved by the microscope, wherein said images are made high-contrast and comprise details that are visible to a human observer instead of being saturated.

One advantage of the invention is that the representations (generated by interferometric imaging and intensity imaging) of the two types of particles share the same spatial frame, since they have been obtained strictly with the same bright-field device. If the distance between the microscope and the object plane conjugated with the camera by the microscope is mechanically stabilized, there is therefore a quantitative means of imaging particles of dimensions smaller or larger than the resolution limit of the microscope, in a sectioned manner.

It is especially possible to observe sets of resolved or unresolved particles the evolution of which is not merely spatial (i.e. a set of separate particles wherein some particles are resolved and some particles are unresolved) but also temporal (i.e. a set of different dimensions of the same particle, as for example in the case of the various sizes of a bubble the size of which continuously increases from an unresolved diameter to a resolved diameter). In the present application, in all the embodiments of the invention, the expression “a set of particles” covers at least a set that can be subject to these two kinds of evolution.

One advantage of the invention is the ability to obtain both types of imaging with the same instrument and therefore, naturally, to unite, in the same spatial frame, both types of imaging (interferometry between scattered and direct light and conventional intensity imaging) automatically performed by the microscope depending on particle size.

It is therefore possible, reliably, by virtue of the method of the embodiment described above, not only to take measurements of the distance between two resolved particles or between two unresolved particles, but also to take measurements of the distance between a resolved particle and an unresolved particle.

This embodiment therefore makes it possible to obtain sectioned imaging of natural resolved and unresolved particles, in a section of thickness equal to the depth of field of the microscope.

Furthermore, it is possible to apply the steps of acquiring and increasing the optical contrast of the image at the same time, to achieve real-time imaging, or else in a temporally offset manner, to obtain non-real-time imaging, after temporal processing of the image with a view to decreasing noise.

For particles of size larger than 10 nm, an exposure time shorter than or equal to 1/130th of a second may be chosen. Generally, this time may be chosen so as to freeze the Brownian motion of the fastest moving particles, i.e., to ensure that the movement of the smallest particles to be imaged is not resolved by the microscope in the exposure time of the stroboscopic image.

Fora minimum exposure time, a minimum size of the particles that it is possible to image with the device and the method of this embodiment, i.e., the interferometric resolving power of the device of the invention, may thus be calculated.

The adjustment of the brightness of the image meets the condition of maximizing, or overexposing to the maximum, the bright background, under the constraints of saturating neither the interferometric image nor the intensity image, this being an adjustment that is conventional in microscopy. This adjustment may be made to the stroboscopic image observed on a display by a human observer.

In this bright-field device, the source of illumination may be a source of any type, such as a heat source of the lamp type, a light-emitting diode (LED) or a laser. As regards the microscope, the resulting illumination may be spatially coherent or incoherent, and/or temporally coherent or incoherent.

The device of this embodiment therefore makes it possible to jointly achieve, with the same bright-field microscope, both interferometric imaging (via scattered and direct light) and intensity imaging (via attenuated direct light).

To improve the contrast of the stroboscopic image or of a time-average thereof, it is possible in particular to apply a histogram extension or expansion, also known as image normalization, the stroboscopic image being, due to its bright background, particularly saturated toward the whites and generally not revealing any visible detail to the naked eye. Distributing the histogram of the image over the entire range of the levels of the image is thus a particularly effective way of increasing contrast. It will be noted that, in conventional or resolved microscopy of phase objects, this situation corresponds to a defective microscopy set up in which the illumination conditions have not been optimized, and in which a wide range of the lowest grayscale levels of the camera is not required.

With a system merely comprising a bright-field microscope, a system (in particular a camera) allowing images to be acquired stroboscopically and image-processing means for improving the contrast of an image, a device is thus obtained that is able, when it is applied to the observation of a natural sample, to generate a simultaneous image of phase objects in Brownian motion, without size-dependent physical filtering of the particles.

It will be noted that the normalization operation improves the contrast of the interference patterns of the unresolved particles and of the intensity patterns of the resolved particles.

Many variant embodiments are possible, in particular by implementing a translation of the histogram of the stroboscopic image, though this results in a lower-contrast stroboscopic image after processing.

It is also possible, depending on the type of particles observed, to apply linear or non-linear normalization operations to the histogram of the stroboscopic image. In particular, since the intensities of the resolved/unresolved particles generally change from sample to sample, each non-linear normalization may be sample-specific.

Any other method allowing a background to be removed from the stroboscopic image and its contrast to be improved may also be used with the invention.

In all the embodiments of the invention, the procedure will therefore begin with overexposing, by means of a source used at its maximum power, the image recorded by a camera via a microscope, with a view to digitally correcting this overexposure subsequently. This method makes it possible to obtain, in a single image, intensity variations (visible to the human eye) for the nanoparticles not resolved by the microscope, at the same time as intensity variations (visible to the human eye) for the microparticles resolved by the microscope. In other words, this method makes it possible to obtain, in a single image, variations in light intensity that are related to interferences with scattered light resulting from the presence of unresolved nanoparticles in the observed medium, at the same time as variations in light intensity that are related to the presence of resolved microparticles in the same medium.

The invention is particularly suitable for the observation, by an observer, of populations of particles, in the case where the size of each particle of the population is comprised between 10 nm and 10 microns, or in the case where populations comprise both particles that are not resolved and particles that are resolved by an optical microscope operating in the visible.

In the context of the invention, a “histogram” is understood to mean the distribution of light intensities or of the “grayscale levels” in a digital image. The invention is industrially applicable or usable in the field of microscopy.

The embodiments or examples of embodiment described in the present disclosure have been given by way of illustration and are non-limiting; a person skilled in the art will easily be able, in light of this disclosure, to modify these embodiments or examples of embodiment, or to envisage others thereof, while remaining within the scope of the invention.

In particular, a person skilled in the art will easily be able to envision variants comprising only some of the features of the embodiments or examples of embodiment described above, if these features are alone sufficient to achieve one of the advantages of the invention. In addition, the various features of these embodiments or examples of embodiment may be used alone or be combined with one another. When they are combined, these features may be combined such as described above or otherwise, the invention not being limited to the specific combinations described in the present description. In particular, unless otherwise specified, a feature described in relation to one embodiment or example of embodiment may be applied in an analogous manner to another embodiment or example of embodiment.

1. A method for obtaining an image, using a microscope (1), of a set of particles, which are conjugated with a digital camera (3) via the microscope (1), the set of particles comprising nanoparticles not resolved by the microscope (1) and microparticles resolved by the microscope (1), wherein the particles are illuminated by a light source (2), and wherein the light source (2) illuminates the digital camera (3) via the microscope (1), the method comprising the following steps:
overexposing an image recorded by the digital camera (3), by means of the light source (2), in order to cause to appear in the recorded image, to an observer, variations in light intensity for the nanoparticles; and,
digitally correcting the overexposure of the recorded image, in order to cause to appear in the recorded image, to the observer, variations in light intensity for the microparticles simultaneously with the variations in light intensity for the nanoparticles.

2. The method as claimed in claim 1, wherein the nanoparticles comprise viruses and wherein the microparticles comprise virus aggregates.

3. The method as claimed in claim 1, wherein the digital correction of the overexposure is obtained via transformation of the histogram of the image.

4. The method as claimed in claim 3, wherein the transformation of the histogram of the image is an extension of the histogram of the image.

5. The method as claimed in claim 3, wherein the transformation of the histogram of the image is a translation of the histogram of the image.

6. The method as claimed in claim 4, wherein the extension of the histogram of the image is linear.

7. The method as claimed in claim 4, wherein the extension of the histogram of the image is non-linear.

8. The method as claimed in claim 3. wherein the transformation of the histogram of the image comprises an extension of the histogram of the image and a translation of the histogram of the image.

9. An imaging device comprising a microscope (1), a light source (2) and a digital camera (3), the imaging device being configured to obtain an image, using the microscope (1), of a set of particles, which are conjugated with the digital camera (3) via the microscope (1), the set of particles comprising nanoparticles not resolved by the microscope (1) and microparticles resolved by the microscope (1),
wherein the particles are illuminated by the light source (2),
wherein the light source (2) illuminates the digital camera (3) via the microscope (1), and,
wherein the light source (2) is of sufficient light intensity to overexpose an image recorded by the digital camera (3) via the microscope (1) and to cause to appear in the recorded image, to an observer, variations in light intensity for a nanoparticle conjugated with the digital camera (3) via the microscope (1),
the device further comprising digital means for correcting the overexposure of the image recorded by the camera (3), in order to cause to appear in the recorded image, to the observer, variations in light intensity for the microparticles simultaneously with the variations in light intensity for the nanoparticles.
